(19) United States
(12) Patent Application Publication
(10) Pub. No.: US 2010/0290943 A1
(43) Pub. Date: Nov. 18, 2010

(54) METHOD TO PRODUCE SINTERING POWDER BY GRINDING PROCESS WITH CARBON NANO TUBE

(76) Inventors: Woong LEE, Anyang-si (KR); Heekyu CHOI, Dongnae-gu (KR)

Correspondence Address: SCHMEISER, OLSEN & WATTS, 22 CENTURY HILL DRIVE, SUITE 302, LATHAM, NY, 12110, US

(21) Appl. No.: 12/742,112

(22) PCT Filed: Feb. 26, 2008
(86) PCT No.: PCT/KR2008/001111

§ 371 Date: May 10, 2010

(30) Foreign Application Priority Data
Nov. 30, 2007 (KR) 10-2007-0123308

(51) Int. Cl. B22F 1/00; B22F 3/10; B02C 23/00; B02C 23/18

(52) U.S. Cl. 419/11; 241/15; 241/22

(57) ABSTRACT

Disclosed herein is a method of producing high-quality sintering powder by grinding metal powder along with carbon nanotube (CNT) particles.

More particularly, the present invention relates to a method of producing high-quality sintered compact by sintering well-dispersed powder prepared using advanced CNT composite to prevent cohesion of particles.

### TECHNICAL FIELD

The present invention relates to a method of producing high-quality sintering powder by grinding metal powder mixed with carbon nanotube (CNT) particles.

More particularly, the present invention relates to a method of producing a high-quality sintered compact by sintering well-dispersed powder prepared using a CNT composite to prevent cohesion of particles.

### BACKGROUND ART

Sintering is a process of forming a porous solid material or a composite material of two materials (for example, metals and ceramics) that do not mix with each other in a molten state.

During sintering, solid particles are placed in a mold and compressed to provide a preform having a predetermined hardness by means of a press. Then, when the preform is heated to a temperature close to the melting point of the material, a sintered compact can be formed as the particles are fused together or some parts of them are coagulated. Metal products can be produced by sintering. This process was first applied to tungsten, which has a high melting point and is difficult to melt.

Recently, sintering is commonly used for various metals. In a conventional sintering process, a raw material is ground to have a small particle size and is then sintered. In this case, chemical grinding aids can be used to prevent cohesion between particles. However, there has been reported no case of using CNT to prevent the cohesion of particles and obtain well-dispersed powder and sintering the powder to produce high-quality products.

In the conventional sintering process, dispersion of metal (for example, aluminum) particles is often interfered with by cohesion between the particles.

Further, the cohesion of particles often leads to decreased density and large pore size.

### DISCLOSURE

### Technical Problem

Therefore, the present invention has been made in view of the above problems and it is an object of the present invention to provide a method of producing a high-quality sintered product with well-dispersed powder.

It is another object of the present invention to provide a method of producing powder in an optimum dispersion state by grinding a mixture prepared with CNT.

### Technical Solution

In accordance with an aspect of the present invention, a method of producing sintering powder comprises adding a predetermined amount of carbon nanotube (CNT) to a raw powder material, and mixing the CNT with the raw powder material and grinding the mixture.

Preferably, the method further comprises dispersing the CNT in ethanol before adding the CNT to the raw powder material.

Preferably, 2 wt % of CNT is added to 98 wt % of the raw powder material.

Preferably, the raw powder material is aluminum powder and the aluminum powder is sintered at 550° C.

As will be described in Examples described below, the CNT acts as not only a grinding aid but also a dispersant, and prevents cohesion of aluminum particles. When aluminum is ground alone, the particles tend to coagulate into spheres. However, when CNT is added, only the particle size of the powder material is reduced without changing particle shape or other characteristics thereof. Thus, the present invention presents a new application of CNT as a grinding aid which reduces only the particle size of aluminum without changing other characteristics thereof. That is, particles useful for the manufacture of nano-composites can be prepared without using another grinding aid during grinding or dispersing, since the CNT functions as the grinding aid.

### ADVANTAGEOUS EFFECTS

The method of producing sintering powder according to the present invention enables the production of well-dispersed aluminum powder by mixing aluminum particles with CNT powder and grinding the mixture.

Desired dispersion of particles can be obtained by preventing cohesion of the powder during the sintering of aluminum powder.

Further, the problem of pore size increase caused by cohesion of the particles during sintering of aluminum powder can be solved.

In addition, although aluminum particles tend to coagulate into spheres when the aluminum particles are ground alone using a ball mill, CNT allows only the particle size of the raw powder material to be reduced without significantly changing particle shape or other characteristics thereof. Thus, the present invention proposes a new application of CNT as a grinding aid which reduces only the particle size of aluminum without changing other characteristics thereof. That is, since the CNT serves as a suitable grinding aid, particles useful for the manufacture of nanocomposites can be prepared without other grinding aids during grinding or dispersing.

### DESCRIPTION OF DRAWINGS

FIG. 1 is a flow chart illustrating a method of producing a high-quality sintered compact according to one embodiment of the present invention;

FIGS. 2a and 2b are SEM micrographs of aluminum and CNT used for experiment;

FIGS. 3a to 3f are SEM micrographs of aluminum powder ground at different times, in which FIGS. 3a to 3f correspond to 12 h, 18 h, 24 h, 36 h, 48 h, and 72h, respectively;

FIGS. 4a to 4f are SEM micrographs of CNT-Al powder ground at different times, in which FIGS. 4a to 4f correspond to 12 h, 18 h, 24 h, 36 h, 48 h, and 72h, respectively;

FIGS. 5a to 5d are graphs depicting particle size frequency distributions (FIGS. 5a and 5b) and cumulative particle size distributions (FIGS. 5c and 5d) of aluminum powder and Al-CNT powder in relation to grinding times;

FIGS. 6a and 6b are graphs depicting change of density and porosity of a sintered aluminum compact and a sintered Al-CNT compact; and

FIG. 7 is a graph depicting hardness change of a sintered aluminum compact and a sintered Al-CNT compact.

### BEST MODE

Research into CNT reinforced composites is actively under way as a main application of CNT in many countries, including the U.S. and Europe.

Research into CNT reinforced composites is mainly focused on CNT dispersal, CNT orientation, CNT/polymer interface control, CNT composite high-dimensional structuralization, and the like. These techniques encompass those necessary for the long-term objective of realizing an ultra-high-strength composite, from basic materials, to reinforcement/matrix composites, to reinforcement/matrix interfacial bindings, to orientation in reinforcement/matrix composites, etc.

As a matrix material for CNT, polymer-based materials are widely used. Meanwhile, it is expected that composite materials with improved strength, toughness, wear resistance, creep resistance, and the like may be obtained by dispersing CNT in ceramics or metallic materials. However, research in this area is still insufficient.

As research continues, ceramics or metal-matrix nanocomposites will be used more widely than polymer-based matrices, particularly in the aerospace industry, because of their superior heat resistance and wear resistance. Whereas research into clay-dispersed composites is led by corporations, those on polymer-based CNT-dispersed nanocomposites are actively carried out by universities, including Georgia Tech, Rice University, Pennsylvania State University, University of Cambridge, Northwestern University and University of Delaware, and research institutes such as NASA.

Major research accomplishments showed that addition of about 2-8 wt % of CNT to a polymer matrix resulted in about 200% improvement of tensile strength, about 350% improvement of rigidity, and about 60% improvement of hardness.

In Korea, research is generally focused on functional rather than structural nanocomposites. Research on CNT dispersed composites is also carried out with regard to the development of CNT/polymer composites for displays based on the electrical properties of CNTs. As yet, significant research on high-strength, ultralight CNT reinforced composites for structural purposes has not yet entered manufacturing, design, simulation, or analysis.

The development of functional nanocomposites has been designated as a basic industry in a petrochemical organic new material division for next-generation industrial growth in Korea, and, as such, research on the development of functional nanocomposites is expected to progress rapidly. However, research on nanocomposites for structural purposes is relatively lacking, considering the scale of Korea's automobile industry or the level of the Korean aerospace industry.

Research on nanocomposites carried out thus far has been led by chemical engineers and is mainly focused on manufacturing techniques such as synthesis and manufacture of reinforcements for polymer matrix composites, fusion of reinforcements in matrices through dispersion, molding of final composites, and the like.

Further, the applications of nanocomposites have also been preferred for the fields of electricity, electronics, optics, chemistry, chemical engineering, etc. In additions, evaluation of physical properties of composites has also focused on electrical, optical and chemical ones rather on mechanical behavior and structural performance. In the early stages of the development of nanocomposites, research on the plausibility of manufacture and physical properties is very important.

For more systematic and effective R&D activities with regard to the manufacture of structural composites having desirable properties using various matrices and reinforcing materials, establishment of a theoretical framework will be necessary.

However, not just inside Korea but also abroad, research on the prediction and evaluation of physical properties or structural behaviors of nanocomposites is not sufficient. Such research is just beginning in many countries. Later, active research will be required for the development and application of nanocomposites.

### MODE FOR INVENTION

Preferred embodiments of the present invention will hereinafter be described in detail with reference to the accompanying drawings.

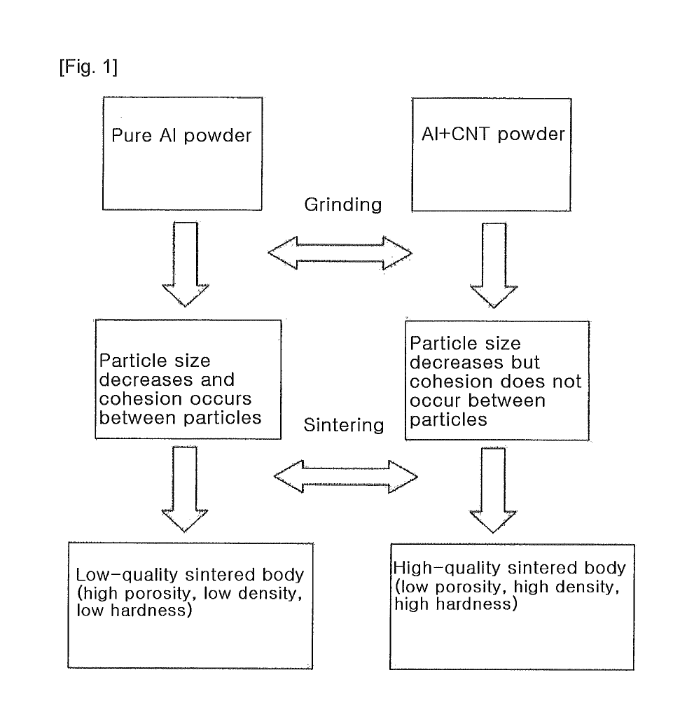

FIG. 1 is a flow chart illustrating a method of producing a high-quality sintered compact according to one embodiment of the present invention. Composition of source materials and manufacture process according to the present invention will be described in detail with reference to FIG. 1. Conditions for grinding experiments are given in Table 1.

In order to evaluate the role of CNT as a grinding aid, grinding behavior of aluminum powder was observed while grinding a mixture of Multi-Wall CNT (MWCNT) and aluminum powder.

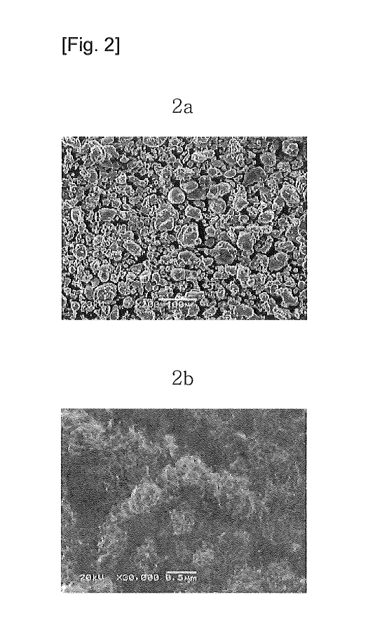

FIGS. 2a and 2b are SEM (scanning electron microscope) micrographs of aluminum powder (×5050) and MWCNT (diameter=about 20 nm, length=about 5) used in the experiment (FIG. 2a: pure Al powder, FIG. 2b: CNT). A commonly used ball mill was used for the grinding experiment.

Experimental conditions are given in Table 1.

TABLE 1
Experimental conditions

| Item | Experimental conditions |
|---|---|
| n (rpm) | 200 |
| d_{B} (mm) | 10 |
| Ball filling ratio ( - ) | 0.3 |
| Sample filling ratio ( - ) | 0.05 |
| Material of media | Steel |
| Temperature | Room temperature |
| Atmosphere | Air |

2 wt % of CNT (0.16 g) was dispersed in ethanol using an ultrasonicator. Then, 98 wt % of aluminum powder (8.15 g) was mixed with the CNT-ethanol solution.

Subsequently, the two components were completely mixed by stirring for 30 minutes using a stirring rod. Then, after evaporating ethanol by drying at 50° C., grinding experimentation was carried out.

The ball mill used for grinding was equipped with a grinding jar (diameter=40 mm, height=55 mm) The weight ratio of the balls to the material was 10:1. The rotating speed of the ball mill was fixed at 200 rpm, and the grinding time was varied from 12 hours to 72 hours.

Particle size distribution of the ground particles was measured using Mastersizer (Malvern Instruments, UK), and SEM micrographs were taken (JSM-5610, JEOL, Japan) for analysis of particle shape and dispersion status.

Sintering was performed using a plasma activated sintering (PAS) apparatus under the condition of 30 MPa and 550° C. The sintering temperature (550° C.) was determined from a preliminary experiment and was identified as the optimum temperature at which the composite can be prepared without forming the compound Al₄C₃. Density and porosity were measured using a density meter based on Archimedes' principle. Mechanical property (hardness) was measured using a micro-Vickers hardness meter.

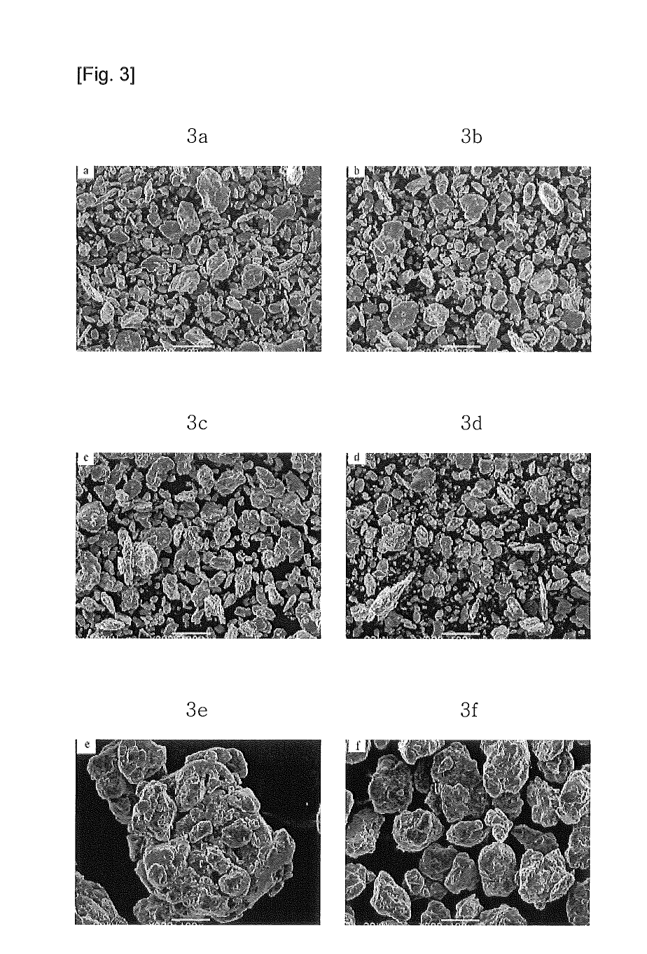

FIGS. 3a to 3f are SEM micrographs of ground aluminum at different times (12 h, 18 h, 24 h, 36 h, 48 h, 72 h). Particle shapes and distribution states of the ground particles can be compared to each other from FIGS. 3a to 3f. When pure aluminum powder was ground without adding CNT, the originally flat particles became spherical ones at 12 hours. At 48 hours, the particles began to coagulate, forming lumps.

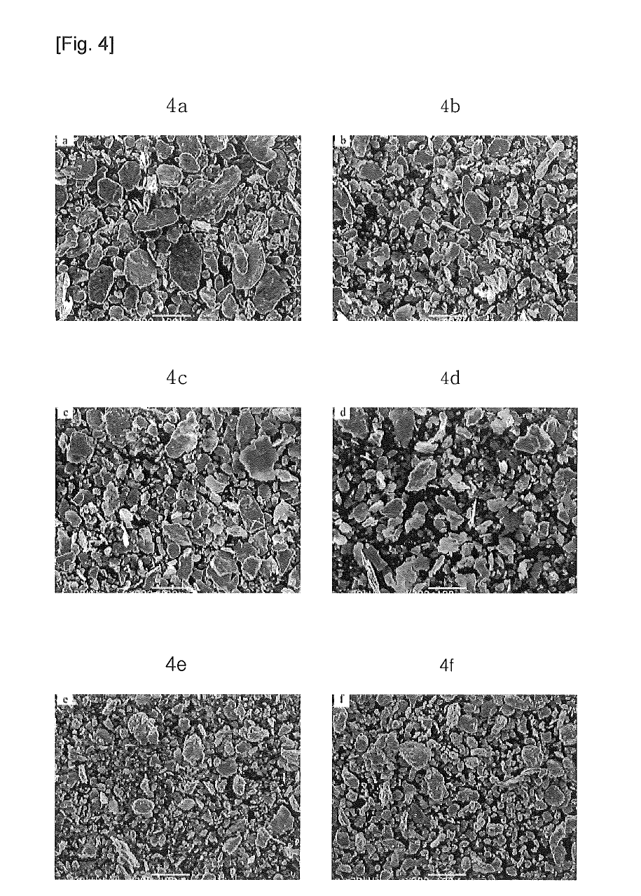

Interestingly, as the grinding time increased, some of the coagulated particles were ground again. Further, the particle surface became rougher as the grinding continued. FIGS. 4a to 4f are SEM micrographs of ground CNT-Al at different times (12 h, 18 h, 24 h, 36 h, 48 h, 72 h).

As seen from FIGS. 4a to 4f, cohesion of particles was not apparent when CNT was added. At an earlier stage of the grinding, particle size decreased little by little, and their original status was maintained (FIG. 4a). Cohesion was not so apparent as when CNT was not added, even at longer times (FIGS. 4b to 4d). At 48 hours, grinding proceeded no further as equilibrium was reached, but cohesion was not observed. Therefore, it can be seen that CNT prevented cohesion of aluminum particles, acting as grinding aid and dispersant.

The ground particles were coagulated into spherical particles when aluminum was ground alone, whereas only the particle size decreased without change in particle shape when CNT was added. Thus, the present invention proposes a new application of CNT as a grinding aid which reduces only the particle size of aluminum without changing other characteristics thereof. That is, particles useful for the manufacture of nanocomposites can be prepared without using another grinding aid during grinding or dispersing, since the CNT functions as a grinding aid.

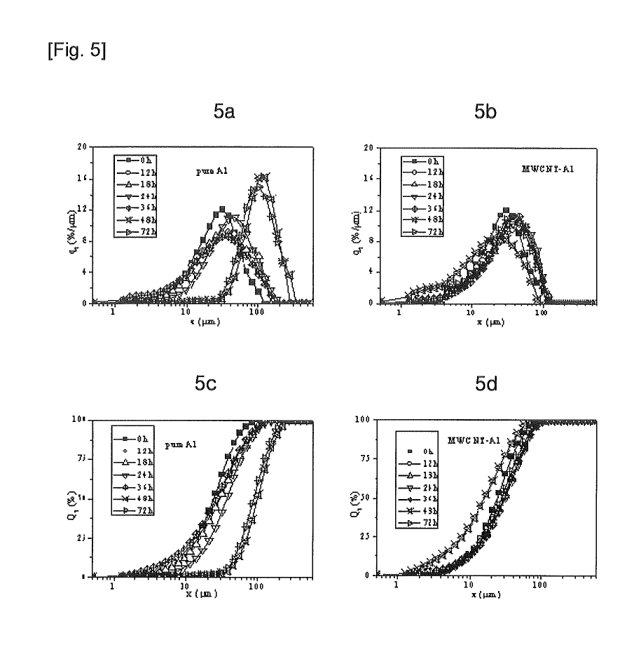

FIGS. 5a to 5d are graph depicting particle size frequency distributions (FIGS. 5a and 5b) and cumulative particle size distributions (FIGS. 5c and 5d) of aluminum powder and Al-CNT powder in relation to grinding times.

As described above, when CNT was used as a grinding aid, the particle size was consistently decreased even after 48 hours because cohesion did not occur. This is because the CNT particles were mixed with the powder materials as described above, preventing cohesion thereof. Further, they adequately prevented cohesion of the balls with the powder materials and with the inner wall of the grinding jar.

Generally, various cohesions can occur during dry grinding. Therefore, the fact that the cohesion was prevented overall implicates that CNT plays an important role as a grinding aid. However, when viewed only from the aspect of ultra-fine grinding of aluminum powder, the particle size decrease obtained from the experiment was not particularly remarkable.

This is because the present invention focused on elucidating the role of CNT as a grinding aid or dispersant and understanding dispersion behaviors of CNT rather than on obtaining ultra-fine particles.

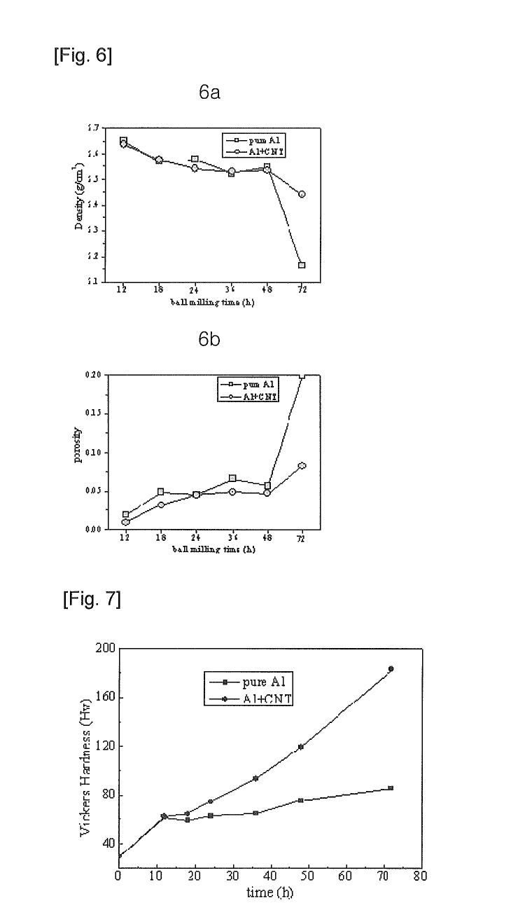

FIGS. 6a and 6b are graphs depicting change of density and porosity of a sintered aluminum compact and a sintered Al-CNT compact. As seen from FIG. 6, sintered pure aluminum and sintered Al-MWCNT compacts showed change in density and porosity.

These sintered compacts did not show a significant difference up to 48 hours of grinding. At 72 hours of grinding, however, the sintered aluminum compact showed an abrupt decrease in density. Similarly, both sintered compacts showed a gradual increase up to 48 hours, but the sintered aluminum compact showed an abrupt increase at 72 hours.

As in the previous results, this also shows that the sintered aluminum compact believed to suffer from uneven dispersion experienced significant cohesion of powder, which causes the porosity increase and the density decrease. In contrast, abrupt increase of porosity was not observed in the Al-CNT composite having even dispersion.

FIG. 7 is a graph depicting hardness change of a sintered aluminum compact and a sintered Al-CNT compact.

As can be seen from FIG. 7, the two sintered compacts showed similar hardness after up to 12 hours. But, thereafter, the sintered Al-CNT composite compact showed a consistent increase of hardness, whereas the sintered aluminum compact showed no further increase.

Increase of hardness in the sintered aluminum compact can be explained based on work hardening caused by a significant degree of plastic deformation during grinding. As a result, the increase of hardness indicates that a high-quality sintered compact was obtained. Here, improvement of hardness was largely dependent on grinding time, when the sintered compact was prepared by adding CNT to the powder material and grinding the mixture of the CNT and powder material. For example, hardness increased by about 113% when the sintered compact was prepared from powder ground for 72 hours.

### INDUSTRIAL APPLICABILITY

The method of producing sintering powder by grinding metal powder along with CNT particles according to the present invention can be applied to the production of high-quality sintered powder materials.

1. A method of producing sintering powder, comprising:
adding a predetermined amount of carbon nanotube (CNT) to a raw powder material; and
mixing the CNT with the raw powder material and grinding the mixture.

2. The method according to claim 1, further comprising:
dispersing the CNT in ethanol before adding the CNT to the raw powder material.

3. The method according to claim 1, wherein 2 wt % of CNT is added to 98 wt % of the raw powder material.

4. The method according to claim 3, wherein the raw powder material is aluminum powder.

5. The method according to claim 4, wherein the aluminum powder is sintered at 550° C.

6. The method according to claim 1, wherein the CNT is used as a grinding aid during the grinding and the dispersing.

7. A method of producing sintering powder, wherein CNT is used as a grinding aid to reduce only a particle size of powder aluminum without changing particle shape or other characteristics of the powder aluminum.
